(19) United States
(12) Patent Application Publication
(10) Pub. No.: US 2015/0066307 A1
(43) Pub. Date: Mar. 5, 2015

(54) MITIGATION OF VEHICLE SHALLOW IMPACT COLLISIONS

(71) Applicant: GM GLOBAL TECHNOLOGY OPERATIONS LLC, Detroit, MI (US)

(72) Inventors: EDUARDO B. BUGELLI, FARMINGTON HILLS, MI (US); MAGDALENA M. PARKILA, ROYAL OAK, MI (US)

(73) Assignee: GM GLOBAL TECHNOLOGY OPERATIONS LLC, Detroit, MI (US)

(21) Appl. No.: 14/019,408

(22) Filed: Sep. 5, 2013

(51) Int. Cl. B60R 21/0136; B60R 21/16

(52) U.S. Cl. CPC B60R 21/0136; B60R 21/16
USPC 701/45; 701/49

(57) ABSTRACT

Methods, systems, and vehicles are provided for mitigating shallow offset vehicle events. A sensor onboard a vehicle provides sensor data. A processor onboard the vehicle is coupled to the sensor. The processor is configured to determine, using the sensor data, whether the vehicle is experiencing a shallow offset event using the sensor data, and initiate rotation of one of a plurality of wheels of the vehicle if the vehicle is experiencing a shallow offset event.

### TECHNICAL FIELD

The present disclosure generally relates to the field of vehicles and, more specifically, to methods and systems for mitigating shallow offset events for vehicles.

### BACKGROUND

Many vehicles today, such as automobiles, have various features that include crumple zones, seat belts, airbags, and other features for mitigating vehicle events. One particular type of event, commonly referred to as a “shallow offset” event, occurs when there is a relatively small overlap between a surface of the vehicle and a surface of a barrier in contact with the vehicle during an impact event. Generally, a shallow offset event is considered to occur when less than a predetermined percentage (e.g., twenty five percent) of the front surface of the vehicle comes into contact with the barrier during the event. During a shallow offset event, the force or energy of the event is spread out among a relatively smaller amount of surface area on the vehicle, and the interaction between the wheels (or tires) and the barrier can cause intrusion to the body structure.

Accordingly, it is desirable to provide improved methods for mitigating shallow offset events for vehicles. It is also desirable to provide systems for mitigating shallow offset events, and to provide vehicles that include such methods and systems. Furthermore, other desirable features and characteristics of the present invention will be apparent from the subsequent detailed description and the appended claims, taken in conjunction with the accompanying drawings and the foregoing technical field and background.

### SUMMARY

In accordance with an exemplary embodiment, a method is provided. The method includes the steps of determining whether a vehicle is experiencing a shallow offset event, and initiating rotation of one of a plurality of wheels of the vehicle via instructions provided by a processor if the vehicle is experiencing a shallow offset event.

In accordance with another exemplary embodiment, a system is provided. The system includes a sensor and a processor. The sensor is onboard a vehicle, and is configured to provide sensor data. The processor is onboard the vehicle, and is coupled to the sensor. The processor is configured to determine, using the sensor data, whether the vehicle is experiencing a shallow offset event using the sensor data, and initiate rotation of one of a plurality of wheels of the vehicle if the vehicle is experiencing a shallow offset event.

In accordance with a further exemplary embodiment, a vehicle is provided. The vehicle includes a plurality of wheels and a drive system. The drive system comprises a sensor and a processor. The sensor is configured to provide sensor data. The processor is coupled to the sensor, and is configured to determine, using the sensor data, whether the vehicle is experiencing a shallow offset event using the sensor data, and initiate rotation of one of the plurality of wheels of the vehicle if the vehicle is experiencing a shallow offset event.

### BRIEF DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a control system, in accordance with an exemplary embodiment;

FIG. 2 is a functional block diagram of a control system that can be used in connection with the vehicle of FIG. 1, in accordance with an exemplary embodiment;

FIG. 3 is a flowchart of a process for mitigating shallow offset vehicle events, and that can be used in connection with the vehicle of FIG. 1 and the control system of FIGS. 1 and 2, in accordance with an exemplary embodiment; and

FIGS. 4-7 are illustrations of certain implementations of certain steps of the process of FIG. 3 in conjunction with the vehicle of FIG. 1 and the control system of FIGS. 1 and 2, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

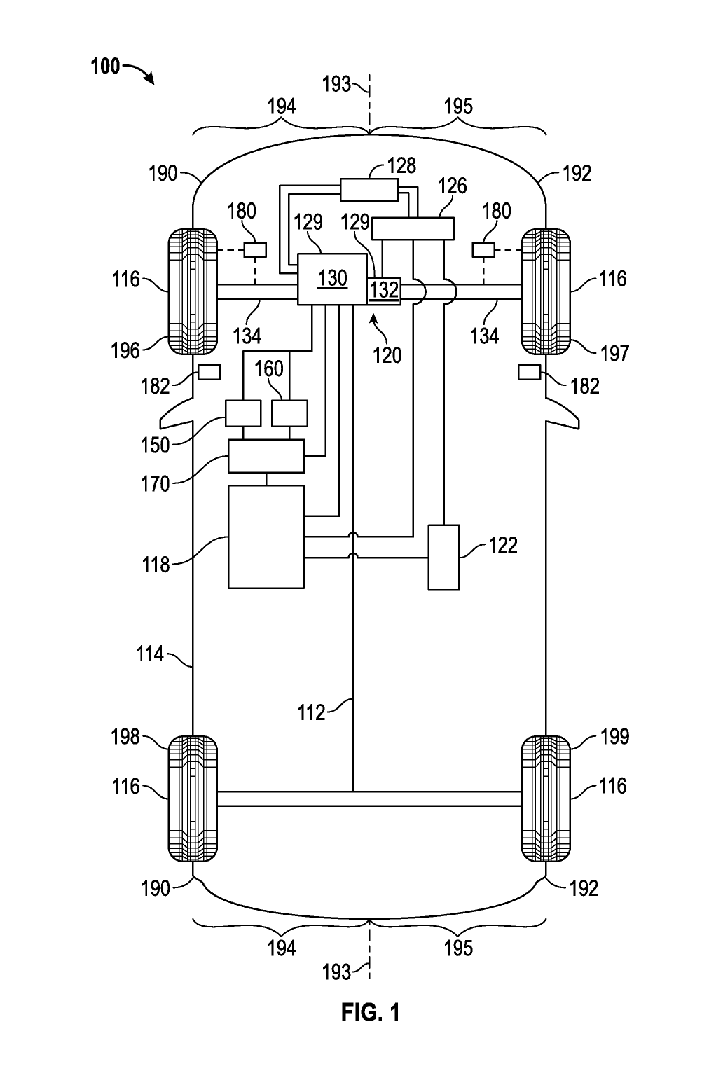

FIG. 1 illustrates a vehicle 100, or automobile, according to an exemplary embodiment. As described in greater detail further below, the vehicle 100 includes a control system 170 that provides functionality that includes mitigation of shallow offset events for the vehicle 100 if the vehicle encounters a barrier.

As depicted in FIG. 1, the vehicle 100 includes a chassis 112, a body 114, four wheels 116, an electronic control system 118, a steering system 150, a braking system 160, and the above-referenced control system 170. The body 114 is arranged on the chassis 112 and substantially encloses the other components of the vehicle 100. The body 114 and the chassis 112 may jointly form a frame. The body 114 (and the vehicle 100) includes a driver side end 190, a passenger side end 192, a center 193, a driver side 194, and a passenger side 195. The center 193 is equidistant from the driver side end 190 and the passenger side end 192. The driver side 194 covers the region between the driver side end 190 and the center 193, and the passenger side 195 covers the region between the passenger side end 192 and the center 193.

The wheels 116 are each rotationally coupled to the chassis 112 near a respective corner of the body 114. In the depicted embodiment, the wheels 116 include a driver side front wheel 196, a passenger side front wheel 197, a driver side rear wheel 198, and a passenger side rear wheel 199.

The vehicle 100 (as well as each of the target vehicles and third vehicles) may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD). The vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and ethanol), a gaseous compound (e.g., hydrogen or natural gas) fueled engine, a combustion/electric motor hybrid engine, and an electric motor.

While the vehicle 100 may comprise any number of different types of vehicles in various embodiments, in one exemplary embodiment illustrated in FIG. 1 the vehicle 100 is a hybrid electric vehicle (HEV), and further includes an actuator assembly 120, an energy storage system (ESS) 122, a power inverter assembly (or inverter) 126, and a radiator 128. The actuator assembly 120 includes at least one electric propulsion system 129 mounted on the chassis 112 that drives the wheels 116. In the depicted embodiment, the actuator assembly 120 includes a combustion engine 130 and an electric motor/generator (or motor) 132. As will be appreciated by one skilled in the art, the electric motor 132 includes a transmission therein, and, although not illustrated, also includes a stator assembly (including conductive coils), a rotor assembly (including a ferromagnetic core), and a cooling fluid or coolant. The stator assembly and/or the rotor assembly within the electric motor 132 may include multiple electromagnetic poles, as is commonly understood.

Still referring to FIG. 1, the combustion engine 130 and the electric motor 132 are integrated such that one or both are mechanically coupled to at least some of the wheels 116 through one or more drive shafts (also referred to herein as axles) 134. In one embodiment, the vehicle 100 is a “series HEV,” in which the combustion engine 130 is not directly coupled to the transmission, but coupled to a generator (not shown), which is used to power the electric motor 132. In another embodiment, the vehicle 100 is a “parallel HEV,” in which the combustion engine 130 is directly coupled to the transmission by, for example, having the rotor of the electric motor 132 rotationally coupled to the drive shaft of the combustion engine 130.

The ESS 122 is mounted on the chassis 112, and is electrically connected to the inverter 126. The ESS 122 preferably comprises a battery having a pack of battery cells. In one embodiment, the ESS 122 comprises a lithium iron phosphate battery, such as a nanophosphate lithium ion battery. Together the ESS 122 and electric propulsion system(s) 129 provide a drive system to propel the vehicle 100.

The radiator 128 is connected to the frame at an outer portion thereof and although not illustrated in detail, includes multiple cooling channels therein that contain a cooling fluid (i.e., coolant) such as water and/or ethylene glycol (i.e., “antifreeze”) and is coupled to the combustion engine 130 and the inverter 126.

The steering system 150 is mounted on the chassis 112, and controls steering of the wheels 116. The steering system 150 includes a steering wheel and a steering column (not depicted). The steering wheel receives inputs from a driver of the vehicle. The steering column results in desired steering angles for the wheels 116 via the drive shafts 134 based on the inputs from the driver.

The braking system 160 is mounted on the chassis 112, and provides braking for the vehicle 100. The braking system 160 receives inputs from the driver via a brake pedal (not depicted), and provides appropriate braking via brake units (also not depicted). The driver also provides inputs via an accelerator pedal (not depicted) as to a desired speed or acceleration of the vehicle, as well as various other inputs for various vehicle devices and/or systems, such as one or more vehicle radios, other entertainment systems, environmental control systems, lightning units, navigation systems, and the like (also not depicted).

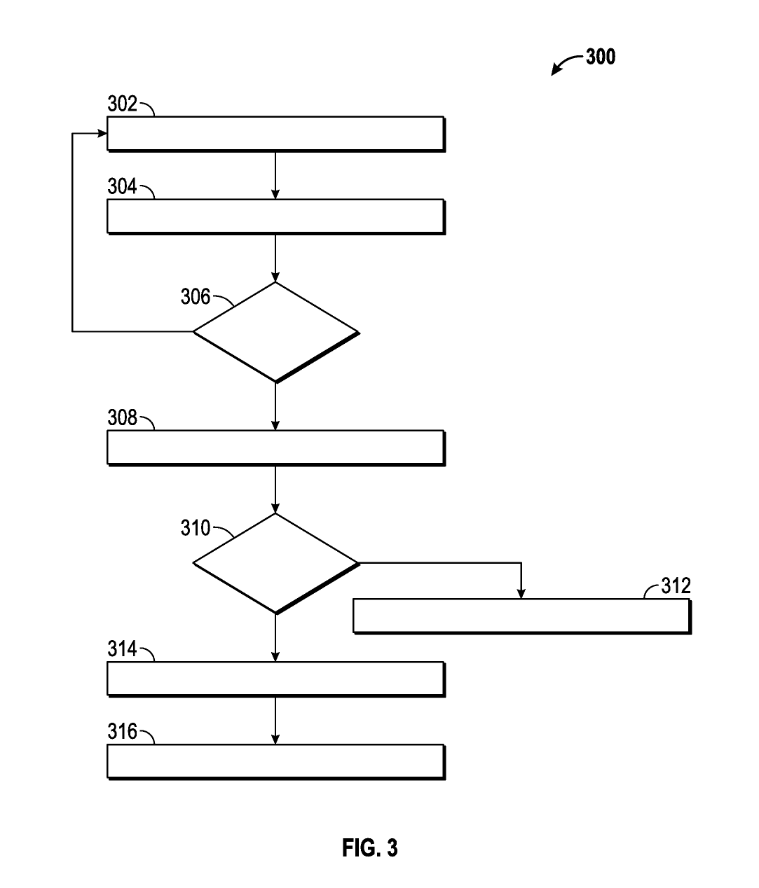

The control system 170 is mounted on the chassis 112. The control system 170 may be coupled to various other vehicle devices and systems, such as, among others, the actuator assembly 120, the steering system 150, the braking system 160, and the electronic control system 118. The control system 170 provides features for the vehicle, including mitigation of shallow offset events involving the vehicle 100 by initiating rotation of one or more of the wheels 116 when a shallow offset event occurs, in accordance with the process described further below in connection with FIGS. 3-7. As discussed further below in connection with the process of FIGS. 3-7, the control system 170 preferably rotates an angle of the front wheels 196, 197 during a shallow offset event (preferably, shortly after the shallow offset begins between the vehicle 100 and a barrier and before the front wheels contact the barrier), with the direction of rotation determined based on the location of impact, to help improve energy management during the shallow offset event.

In certain embodiments, the control system 170 includes or is coupled to one or more actuators 180 that are coupled to one or more of the wheels 116 for initiating rotation of one or more of the wheels 116 via instructions provided by the control system 170 when a shallow offset event occurs. In certain other embodiments, the control system 170 includes or is coupled to one or more actuators 180 that are coupled to the axle 134 for initiating rotation of one or more of the wheels 116 via instructions provided by the control system 170 when a shallow offset event occurs. In certain other embodiments, the control system 170 includes or is coupled to one or more airbags 182 that are disposed proximate one or more of the wheels 116 for initiating rotation of one or more of the wheels 116 via instructions provided by the control system 170 when a shallow offset event occurs.

In addition, although not illustrated as such, the control system 170 (and/or one or more components thereof) may be integral with the electronic control system 118 and may also include one or more power sources. The control system 170 preferably conducts various steps of the process 300 and the steps and sub-processes thereof of FIGS. 3-7.

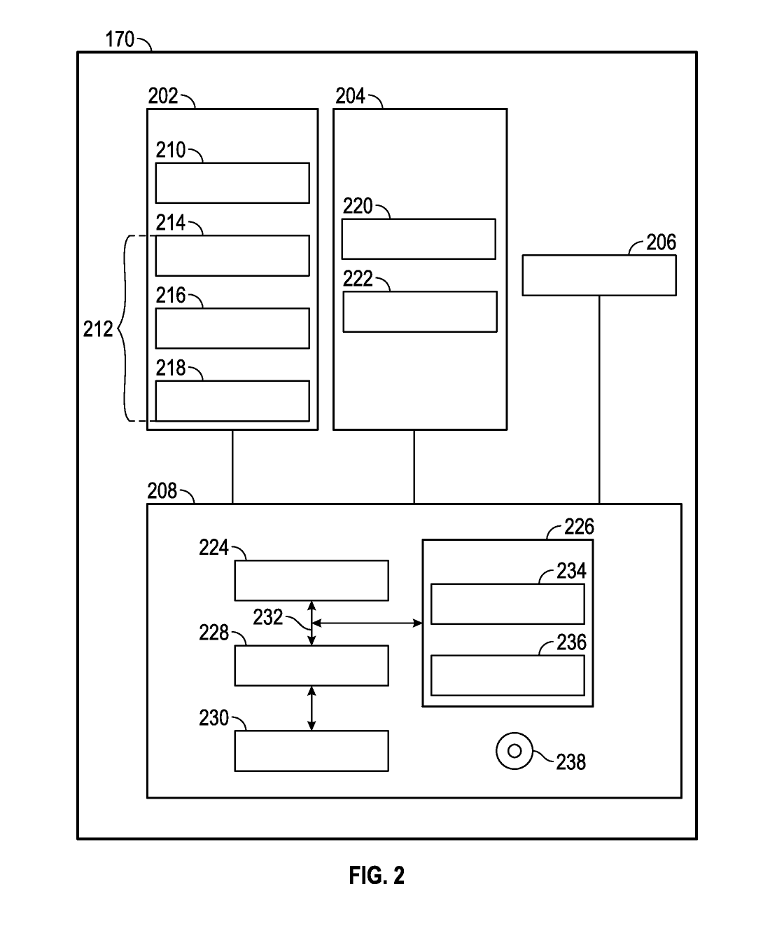

With reference to FIG. 2, a functional block diagram is provided for the control system 170 of FIG. 1, in accordance with an exemplary embodiment. As depicted in FIG. 2, the control system 170 includes a sensor unit 202, an actuator unit 204 and/or airbag unit 206, and a controller 208, each of which are preferably disposed onboard the vehicle 100.

The sensor unit 202 includes an electronic frontal sensor (EFS) 210 and/or one or more additional sensors 212. The EFS 210 is disposed on a front surface of the vehicle 100 of FIG. 1, and utilizes EFS 210 measured values to provide sensor data pertaining to any frontal encounters that may occur between the vehicle 100 and an object (also referred to herein as a barrier). In one embodiment, the EFS 210 is disposed on a structural member of the front of the vehicle. The sensor data from the EFS 210 preferably includes changes in vehicle velocity shortly after impact between the vehicle and the barrier for use in determining whether such an event is a shallow offset event.

The additional sensors 212 (all preferably disposed onboard the vehicle 100) include one or more cameras 214, radar devices 216 (such as long and short range radar detection devices, lasers, and/or ultrasound devices), and/or other detection devices 218 (such as, by way of example, light detection and ranging (LIDAR) and/or vehicle-to-vehicle (V2V) communications). The cameras 214 provide camera data pertaining to the barrier and its positioning respect to the vehicle 100 prior to impact for subsequent use in determining whether an event is a shallow offset event. The radar devices 216 provide radar data pertaining to the barrier and its positioning respect to the vehicle 100 prior to impact for subsequent use in determining whether an event is a shallow offset event, and the other detection devices 218 (if any) utilize their respective technologies in providing similar data.

It will be appreciated that the specific sensors of the sensor unit 202 may vary in different embodiments. For example, in certain embodiments there may be an EFS 210 without any additional sensors 212, or vice versa. By way of further example, the additional sensors 212 may vary, and so on. In each of these embodiments, the sensor unit 202 preferably provides data pertaining to these various types of information to the controller 208 for processing and for mitigating shallow offset vehicle events.

The actuator unit 204 is also coupled to the controller 208. In one embodiment, the actuator unit 204 includes one or more wheel actuators 220 that are connected to one or more of the wheels 116 (preferably to one or more of the front wheels 196, 197) of the vehicle 100 that implement instructions from the controller 208 to initiate rotation of one or more of the wheels 116 during a shallow offset event. In another embodiment, the actuator unit 204 includes one or more axle actuators 222 that are connected to an axle of the vehicle (preferably to the front axle 134) that implement instructions from the controller 208 to initiate movement of the axle, to thereby initiate rotation of one or more of the wheels 116.

The airbag unit 206 is also coupled to the controller 208. In one embodiment, the airbag unit 206 comprises one or more airbags that are disposed proximate (and preferably adjacent to) one or more of the wheels 116 (preferably one or more of the front wheels 196, 197) of the vehicle 100. In one such embodiment, the airbag unit 206 is disposed directly behind, or rearward, of one of the wheels 116. However, this may vary in other embodiments. The airbags are inflated in accordance with instructions provided by the controller 208 to initiate rotation of one or more of the wheels 116 during a shallow offset event.

The controller 208 (preferably disposed onboard the vehicle 100) is coupled to the sensor unit 202, as well as to the actuator unit 204 and/or airbag unit 206. The controller 208 processes the data and information received from the sensor unit 202, makes determinations as to the type of event between the vehicle 100 and a barrier (including whether the event is a shallow offset event, and a side of the vehicle 100 in which the event is occurring), and takes action to mitigate shallow offset events through selective rotation of one or more of the wheels 116 of the vehicle 100 (preferably, via instructions provided to the steering system 150, the actuator unit 204, and/or the airbag unit 206), in accordance with the steps of the process described further below in connection with FIGS. 3-7. The selective rotation of the one or more wheels 116 may be attained via different techniques, such as via the steering system 150, the actuator unit 204, the airbag unit 206, and/or a combination thereof, in various embodiments.

As depicted in FIG. 2, the controller 208 comprises an onboard computer system. In certain embodiments, the controller 208 may also include and/or be part of one or more of the sensor unit 202, the actuator unit 204, and/or the airbag unit 206, and/or components thereof. In addition, it will be appreciated that the controller 208 may otherwise differ from the embodiment depicted in FIG. 2. For example, the controller 208 may be coupled to or may otherwise utilize one or more remote computer systems and/or other control systems.

In the depicted embodiment, the computer system of the controller 208 includes a processor 224, a memory 226, an interface 228, a storage device 230, and a bus 232. The processor 224 performs the computation and control functions of the controller 208, and may comprise any type of processor or multiple processors, single integrated circuits such as a microprocessor, or any suitable number of integrated circuit devices and/or circuit boards working in cooperation to accomplish the functions of a processing unit. During operation, the processor 224 executes one or more programs 234 contained within the memory 226 and, as such, controls the general operation of the controller 208 and the computer system of the controller 208, preferably in executing the steps of the processes described herein, such as the steps of the process 300 (and any sub-processes thereof) in connection with FIGS. 3-7. The processor 224, along with the other components of the controller 208, is preferably disposed onboard the vehicle 100.

The memory 226 can be any type of suitable memory. This would include the various types of dynamic random access memory (DRAM) such as SDRAM, the various types of static RAM (SRAM), and the various types of non-volatile memory (PROM, EPROM, and flash). In certain examples, the memory 226 is located on and/or co-located on the same computer chip as the processor 224. In the depicted embodiment, the memory 226 stores the above-referenced program 234 along with one or more stored values 236 for mitigating shallow offset events (for example, threshold values for determining whether an event is a shallow offset event, and the like).

The bus 232 serves to transmit programs, data, status and other information or signals between the various components of the computer system of the controller 208. The interface 228 allows communication to the computer system of the controller 208, for example from a system driver and/or another computer system, and can be implemented using any suitable method and apparatus. It can include one or more network interfaces to communicate with other systems or components. The interface 228 may also include one or more network interfaces to communicate with technicians, and/or one or more storage interfaces to connect to storage apparatuses, such as the storage device 230.

The storage device 230 can be any suitable type of storage apparatus, including direct access storage devices such as hard disk drives, flash systems, floppy disk drives and optical disk drives. In one exemplary embodiment, the storage device 230 comprises a program product from which memory 226 can receive a program 234 that executes one or more embodiments of one or more processes of the present disclosure, such as the steps of the process 300 (and any sub-processes thereof) of FIGS. 3-7, described further below. In another exemplary embodiment, the program product may be directly stored in and/or otherwise accessed by the memory 226 and/or a disk (e.g., disk 238), such as that referenced below.

The bus 232 can be any suitable physical or logical means of connecting computer systems and components. This includes, but is not limited to, direct hard-wired connections, fiber optics, infrared and wireless bus technologies. During operation, the program 234 is stored in the memory 226 and executed by the processor 224.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 224) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will similarly be appreciated that the computer system of the controller 208 may also otherwise differ from the embodiment depicted in FIG. 2, for example in that the computer system of the controller 208 may be coupled to or may otherwise utilize one or more remote computer systems and/or other control systems.

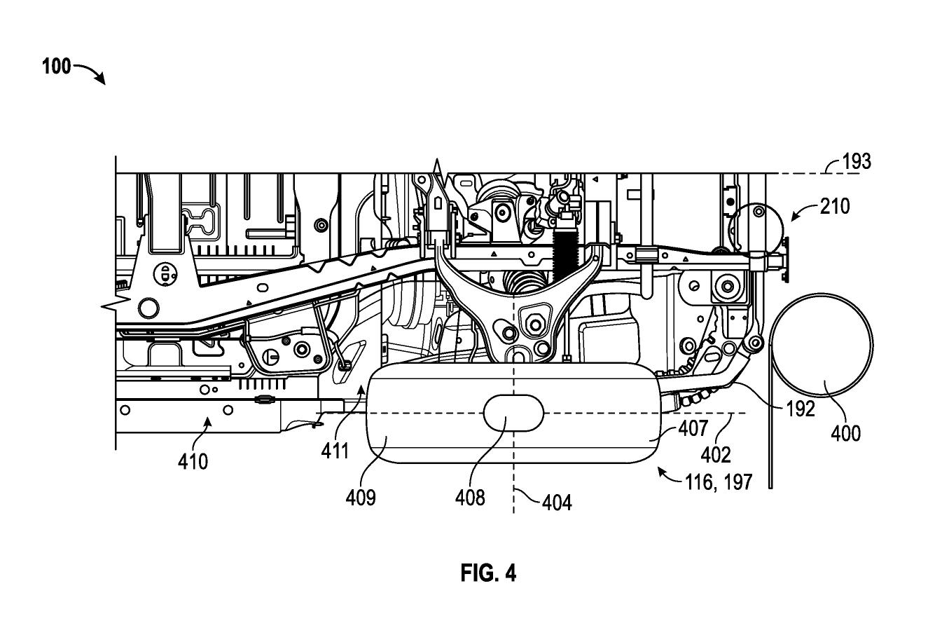

FIG. 3 is a flowchart of a process 300 for mitigating shallow offset events, in accordance with an exemplary embodiment. The process 300 will also be described further below in connection with FIGS. 4-7, which depict the vehicle 100 of FIG. 1 implementing certain steps of the process 300 of FIG. 3 in accordance with an exemplary embodiment. The process 300 can be implemented in connection with the vehicle 100 of FIGS. 1 and 2 and the control system 170 of FIGS. 1 and 2. The process 300 is preferably performed continuously during a current drive cycle (or ignition cycle) of the vehicle.

The process 300 includes the step of obtaining first sensor data (step 302). The first sensor data preferably includes data from one or more of the additional sensors 212 of the sensor unit 202 of FIG. 2 pertaining to a barrier and its position with respect to the vehicle 100 of FIG. 1 prior to an event between the vehicle 100 and the barrier. In one embodiment, the first sensor data comprises camera data from a camera 214 of FIG. 2 pertaining to the barrier and its position with respect to the vehicle 100 prior to the vehicle contacting the barrier. In another embodiment, the first sensor data comprises radar data from a radar device 216 of FIG. 2 pertaining to the barrier and its position with respect to the vehicle 100 prior to the vehicle contacting the barrier. In a further embodiment, the first sensor data comprises other detection data from one or more other detection devices 218 of FIG. 2 (e.g. a LIDAR device) pertaining to the barrier and its position with respect to the vehicle 100 prior to the vehicle contacting the barrier. The first sensor data of step 302 is provided to the controller 208, preferably to the processor 224 thereof, for processing.

Second sensor data is also obtained (step 304). The second sensor data preferably includes data from the EFS 210 of the sensor unit 202 of FIG. 2 pertaining to a measure of any contact between the barrier and the vehicle 100 of FIG. 1 for use in detecting when an event has occurred between the vehicle 100 and the barrier. The second sensor data of step 304 is provided to the controller 208, preferably to the processor 224 thereof, for processing.

A determination is made as to whether the vehicle is experiencing an event (step 306). As used throughout this application, an “event” refers to contact between the vehicle and the barrier as the vehicle encounters the barrier. The determination is preferably made by the processor 224 of FIG. 2 using the second sensor data provided by the EFS 210 of FIG. 2 during step 304. In one embodiment, a determination is made that an event is occurring between the vehicle and a barrier if the second sensor data provided by the EFS 210 indicates that an absolute value of a rate of change in velocity of the vehicle is greater than a first predetermined threshold. The first predetermined threshold is preferably stored in the memory 226 of FIG. 2 as one of the stored values 236 thereof. In certain embodiments, other measurements, such as a sensor's angular velocity/rotation measurements and/or a vehicle deceleration measure, can be used for the determination that the event is occurring.

If it is determined in step 306 that the vehicle is not experiencing an event, then the process returns to step 302. Steps 302-306 then repeat, preferably continuously, with updated first sensor data and second sensor data until a determination is made in an iteration of step 306 that the vehicle is experiencing an event in which the.

Once it is determined in an iteration of step 306 that the vehicle is experiencing an event, third sensor data is obtained (step 308). The third sensor data preferably includes data from the EFS 210 of the sensor unit 202 of FIG. 2 after the event has begun (i.e., after the vehicle has come into contact with the barrier). The first sensor data of step 302 is provided to the controller 208, preferably to the processor 224 thereof, for processing. The third sensor data preferably includes measures of rate of change of velocity of the velocity very shortly after (e.g., a few milliseconds after) an event has begun between the vehicle and a barrier. The third sensor data of step 308 is provided to the controller 208, preferably to the processor 224 thereof, for processing. In certain embodiments, other measurements, such as a sensor's angular velocity/rotation measurements and/or a vehicle deceleration measure, may also be obtained. The various data is preferably provided in parallel from multiple sources (e.g., multiple sensors of the sensor unit 202) to the processor 224.

A determination is made as to whether the event is a shallow offset event (step 310). As mentioned above, a shallow offset event is considered to occur when less than a predetermined percentage of the front surface of the vehicle comes into contact with the barrier during the event. In one such example, this predetermined percentage is equal to twenty five percent. This determination is preferably made by the processor 224 of FIG. 2 via the first sensor data of step 302 and/or the third sensor data of step 308. In certain embodiments, the determination of step 310 is made also using other measurements, such as a sensor's angular velocity/rotation measurements and/or a vehicle deceleration measure.

In one embodiment, a determination is made that the event between the vehicle and the barrier is a shallow offset based on the third sensor data of step 308 that is measured immediately or very shortly after (e.g., a few milliseconds after) the beginning of the event. In one such example, the event is determined to be a shallow offset event if an absolute value of a rate of change in velocity of the vehicle from the third sensor data of step 308 (preferably, generated by the EFS 210 very shortly after the event begins) is greater than a second predetermined threshold. The second predetermined threshold is preferably stored in the memory 226 of FIG. 2 as one of the stored values 236 thereof.

In certain other embodiments, a determination is made as to whether the event between the vehicle and the barrier is a shallow offset based on the first sensor data of step 302 that is generated prior to the beginning of the event. In one such example, the event is determined to be a shallow offset event if camera data from step 302 taken prior to the event indicates that less than twenty five percent of the front surface of the vehicle is about to come into contact with the barrier during the event. In another such example, the event is determined to be a shallow offset event if radar data from step 302 taken prior to the event indicates that less than twenty five percent of the front surface of the vehicle is about to come into contact with the barrier during the event. In certain other such examples, the event is determined to be a shallow offset event if other data (e.g., from a LIDAR device) from step 302 taken prior to the event indicates that less than twenty five percent of the front surface of the vehicle is about to come into contact with the barrier during the event. In certain embodiments, one or more of the cameras 214 and/or radar devices 216 of FIG. 2 recognize the object size and location in front of vehicle and feeds the information to the processor to be part of the decision making process.

In certain embodiments, the first sensor data of step 302 and the third sensor data of step 308 are used together for the determination of step 310 as to whether a shallow offset event is occurring. In other embodiments, the first sensor data of step 302 may be used without the third sensor data of step 308, or vice versa, for determining whether a shallow offset event is occurring. Accordingly, in certain embodiments, one of steps 302 or 308 may not be necessary, and so on.

If it is determined in step 310 that a shallow offset event is not occurring, then standard procedures are implemented for events that are not shallow offset events step (312). For example, in certain embodiments, airbags inside the cabin of the vehicle may be deployed, a fuel pump of the vehicle may be shut down, high voltage electrical vehicle components may be shut down, and so, based on instructions provided by the processor 224 of FIG. 2. However, because the event is not a shallow offset event, the processor 224 of FIG. 2 does not initiate rotation of the wheels during step 312.

Conversely, if it is determined in step 310 that a shallow offset event is occurring, then a determination is made as to a side of the vehicle in which the shallow offset event is predominantly occurring (step 314). During step 314, a determination is preferably made as to whether the shallow offset event is occurring predominantly on the driver side 194 or the passenger side 195 of FIG. 1. This determination is preferably made by the processor 224 using the first data of step 302 and/or the third data of step 308 in determining whether a majority of the front surface of the vehicle 100 in contact with the barrier is located on the driver side 194 versus the passenger side 195 of the vehicle 100. In one embodiment, strategically one or more strategically placed sensors (for example, of the sensor unit 202 of FIG. 2) collect data pertaining to the event, and input the information into a sensing diagnostic module (SDM) (for example, which may be considered part of the controller 108 of FIG. 2), which in turn may process the information and determine, therefrom, the side of the vehicle on which the event is occurring. In one such embodiment, one of the sensors of the sensor unit 202 (e.g., the EFS 210 of FIG. 2) is disposed on a structural member of the front of the vehicle.

In addition, during the shallow offset event, rotation of one or more of the wheels is initiated (step 316). In one embodiment, during step 316, the rotation of the one or more wheels (discussed in greater detail below) is initiated in addition to other standard event procedures, such as the above described deployment of airbags inside the cabin of the vehicle, shutting down of the fuel pump of the vehicle, shutting down high voltage vehicle electrical components, and so on. The actions of step 316 are preferably performed via instructions provided by the processor 224 of FIG. 2.

Similar to the discussion above with respect to FIGS. 1 and 2, in one embodiment of step 316, the processor 224 of FIG. 2 initiates rotation of the front wheels 196, 197 of FIG. 1 during a shallow offset event by providing instructions to a wheel actuator 220 of FIG. 2 that is coupled to one or both of the front wheels 196, 197. In another embodiment of step 316, the processor 224 of FIG. 2 initiates rotation of the front wheels 196, 197 of FIG. 1 during a shallow offset event by providing instructions to an axle actuator 222 of FIG. 2 that is coupled to the front axle 134 of FIG. 1. In a further embodiment of step 316, the processor 224 of FIG. 2 initiates rotation of the front wheels 196, 197 of FIG. 1 during a shallow offset event by providing instructions to one or more airbags disposed adjacent to one or both of the front wheels 196, 197 of FIG. 1. In any of these examples, the processor 224 preferably initiates automatic rotation of one or more of the front wheels 196, 197.

The direction of the wheel rotation initiated in step 316 is based on the side of the vehicle in which the shallow offset event is determined to be occurring, as determined in step 314. Specifically, if it is determined in step 314 that the shallow offset event is occurring predominantly on the driver side 194 of FIG. 1, then wheel rotation is initiated such that a front portion of a wheel on the driver side of the vehicle is turned inward toward a center of the vehicle. Conversely, if it is determined in step 314 that the shallow offset event is occurring predominantly on the passenger side 195 of FIG. 1, then wheel rotation is initiated such that a front portion of a wheel on the passenger side of the vehicle is turned inward toward a center of the vehicle.

The magnitude of rotation of step 316 may vary in different embodiments. In one embodiment, the wheels are rotated approximately ten degrees, for example, for an average sedan. However, the magnitude of the rotation may vary in different embodiments, and may vary based on the type of vehicle (for example, certain relatively larger vehicles may require a larger magnitude of rotation). For example, for full size trucks, the wheel rotation may be in the range of 15-17 degrees in certain embodiments, and so on.

With reference to FIGS. 4-7, illustrations are provided of certain implementations of certain steps of the process 300 of FIG. 3 in conjunction with the vehicle 100 of FIG. 1 and the control system 170 of FIGS. 1 and 2, in accordance with an exemplary embodiment. The example of FIGS. 4-7 pertains to a shallow offset event between the vehicle 100 and a barrier (also referred to herein as an object) 400. FIGS. 4-7 depict movement of the passenger side front wheel 197 during a shallow offset event that occurs predominantly on the passenger side 195 of the vehicle 100 of FIG. 1. FIGS. 4-7 include designations for a front portion 407, a center 408, and a rear portion 409 of the wheel 197 with respect to a first axis 402 (extending between the front and rear ends of the vehicle) and a second axis 404 (extending between the driver and passenger ends of the vehicle 100).

FIG. 4 depicts the vehicle 100 just prior to the event with the barrier 400. As depicted in FIG. 4, assuming that the vehicle 100 is not engaging in a turn, the front 407, center 408, and rear 409 portions of the vehicle 100 are each aligned with the first axis 402. In addition, a lower dash 410 region and rocker structure 411 are also depicted for the vehicle 100.

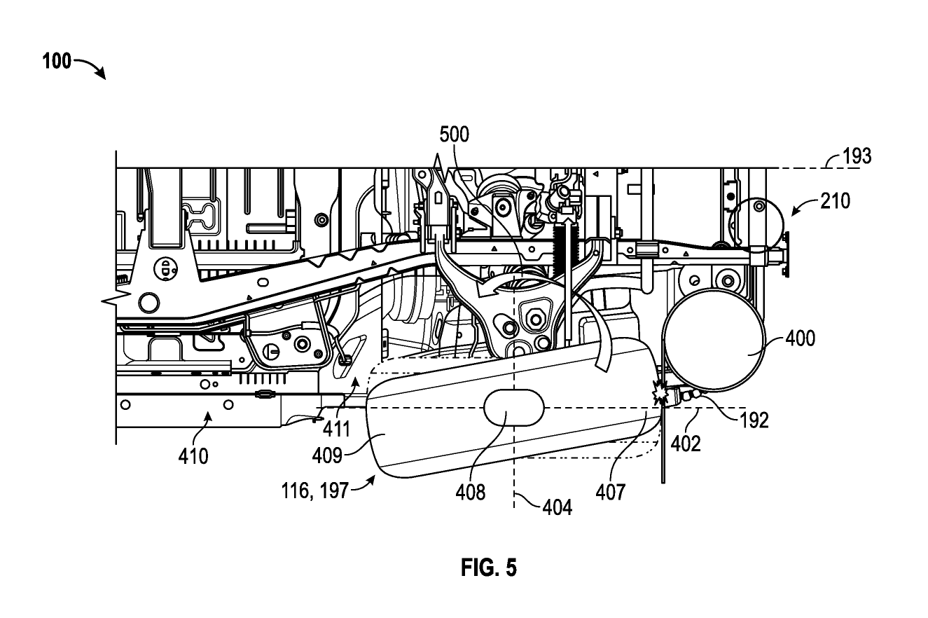

FIG. 5 depicts the vehicle 100 shortly after the beginning of the event with the barrier 400. As depicted in FIG. 5, once the processor 224 of FIG. 2 determines that the event is a shallow offset event along with the side of the vehicle 100 on which the event is predominantly occurring (i.e., the passenger side 195, in the depicted embodiment) in steps 310 and 314 of FIG. 3, the processor 224 provides instructions that result in the front portion 407 of the passenger side front wheel 197 to turn (i.e., rotate) inward toward the center 193 of the vehicle 100 along direction 500 depicted in FIG. 5. Alternatively sated, the rear portion 409 of the passenger side front wheel 197 begins to turn (i.e. rotate) outward away from the center 193 of the vehicle 100. Furthermore, because the driver side front wheel 196 and the passenger side front wheel 197 are both connected to the axle 134 of FIG. 1, the driver side front wheel 196 of FIG. 1 will rotate such that the front portion of the driver side front wheel 196 turns away from the center 193 of the vehicle 100 while the rear portion of the driver side front wheel 196 turns toward the center 193 of the vehicle 100 under the conditions depicted in FIG. 5. As mentioned above, in one embodiment, the wheels 116 are rotated approximately ten degrees in this manner with respect to the first axis 402. However, the magnitude of the rotation may vary in different embodiments, and may vary based on the type of vehicle (for example, certain relatively larger vehicles may require a larger magnitude of rotation).

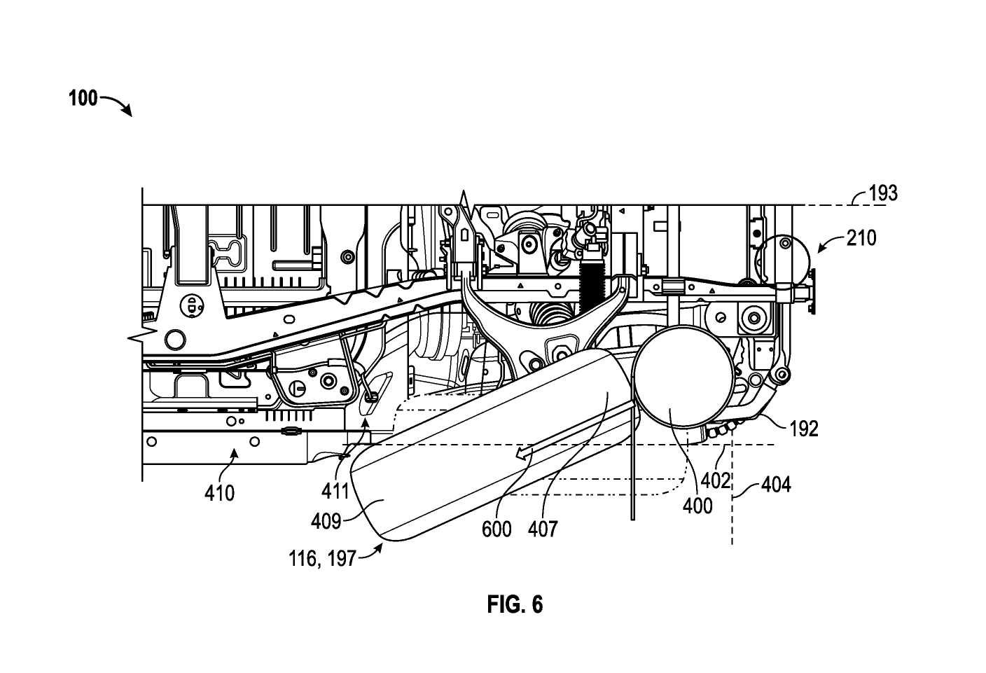

FIG. 6 depicts the vehicle 100 a short time period (for example, a few milliseconds) after the conditions of FIG. 5, but just before the wheel 197 (or tire surrounding the wheel 197) contacts the barrier 400. As depicted in FIG. 6, in one embodiment, the wheel 197 may break off from a knuckle of the vehicle 100 along direction 600 as the wheel 197 (or the tire surrounding the wheel 197) contacts that barrier 400 and the barrier 400 loads the wheel 197 (or the tire surrounding the wheel 197).

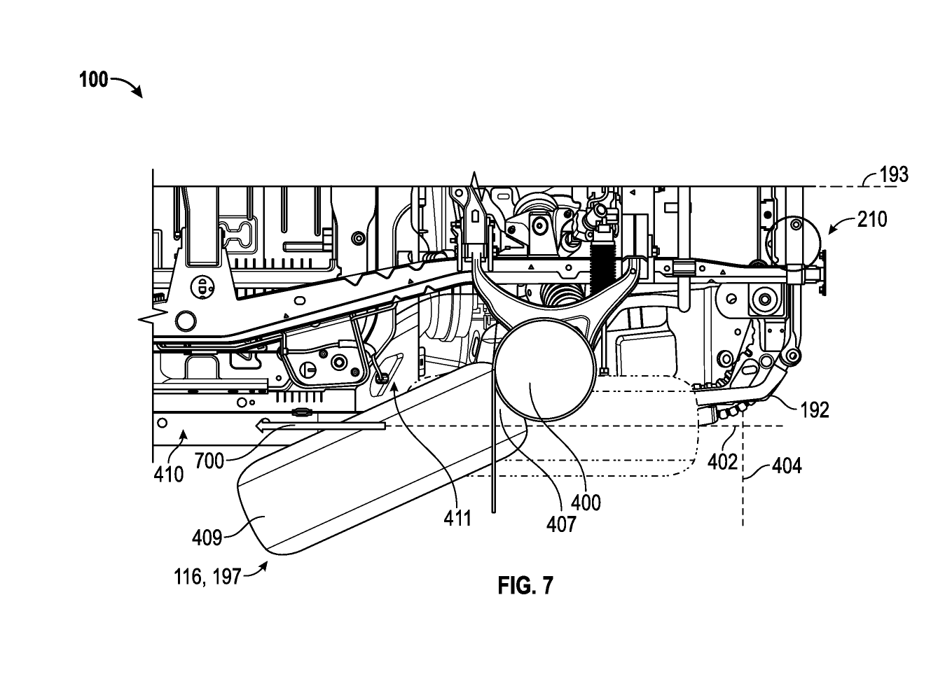

FIG. 7 depicts the vehicle 100 after the wheel 197 (or tire surrounding the wheel 197) contacts the barrier 400. As depicted in FIG. 7, at this point the wheel 197 preferably detaches from the vehicle 100 itself along direction 700. This results in a load in the rocker structure 411, but not the lower dash 410 region, of the vehicle.

The shallow offset mitigation illustrated in FIGS. 3-7 can help to improve energy management for the vehicle during a shallow offset event. For example, the selective wheel rotation helps to avoid situations that may occur during a typical shallow offset event (without the selective wheel rotation), which can cause intrusion and unwanted loads to the body structure via the wheel's engagement of the barrier during a typical shallow offset event.

While FIGS. 4-7 depict an example in which the shallow offset event occurs predominantly on the passenger side 195 of the vehicle 100, this example can be easily extrapolated to a second example in which the shallow offset event occurs predominantly on the driver side 194 of the vehicle 100. In such a second example, FIGS. 4-7 would remain essentially the same, except that a front portion of driver side front wheel 196 would rotate inward toward the center 193 of the vehicle 100, while a rear portion of driver side front wheel 196 would rotate outward away from the center 193 of the vehicle 100. Similarly, in such a second example in which the shallow offset event occurs primarily on the driver side 194 of the vehicle, the front portion 407 of the passenger side front wheel 197 (because it is connected to the driver side front wheel 196 via axle 134) would rotate outward away from the center 193 of the vehicle 100, while the rear portion 149 of the passenger side front wheel 197 would rotate inward toward the center 193 of the vehicle 100.

Accordingly, methods and systems, and vehicles are provided for mitigating shallow offset vehicle events. While a shallow offset event is occurring, one or more of the wheels of the vehicle or selectively rotated during the event to help mitigate the effects of the event.

It will be appreciated that the disclosed methods, systems, and vehicles may vary from those depicted in the Figures and described herein. For example, the vehicle 100, control system 170, and/or various components thereof may vary from that depicted in FIGS. 1 and 2 and described in connection therewith. In addition, it will be appreciated that certain steps of the process 300 may vary from those depicted in FIGS. 3-7 and/or described above in connection therewith. It will similarly be appreciated that certain steps of the process described above (and/or sub-processes or sub-steps thereof) may occur simultaneously or in a different order than that depicted in FIGS. 3-7 and/or described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

We claim:

1. A method comprising:
determining whether a vehicle is experiencing a shallow offset event; and
initiating rotation of one of a plurality of wheels of the vehicle via instructions provided by a processor if the vehicle is experiencing a shallow offset event.

2. The method of claim 1, further comprising:
determining whether the shallow offset event is occurring on a driver side or a passenger side of the vehicle;
wherein the step of initiating rotation comprises:
initiating rotation such that a front portion of a wheel on the driver side of the vehicle is turned inward toward a center of the vehicle, if the shallow offset event is determined to be occurring on the driver side of the vehicle; and
initiating rotation such that a front portion of a wheel on the passenger side of the vehicle is turned inward toward the center of the vehicle, if the shallow offset event is determined to be occurring on the passenger side of the vehicle.

3. The method of claim 1, wherein:
the step of initiating rotation comprises initiating rotation of one of the plurality of wheels via an actuator coupled to the one of the plurality of wheels if the vehicle is experiencing a shallow offset event.

4. The method of claim 1, wherein:
the step of initiating rotation comprises initiating rotation of one of the plurality of wheels via an actuator coupled to an axle of the vehicle if the vehicle is experiencing a shallow offset event.

5. The method of claim 1, wherein:
the step of initiating rotation comprises inflating an airbag proximate one of the plurality of wheels if the vehicle is experiencing a shallow offset event.

6. The method of claim 1, wherein the step of determining whether the vehicle is experiencing a shallow offset event comprises:
determining a velocity of the vehicle; and
determining whether the vehicle is experiencing a shallow offset event using the velocity.

7. The method of claim 1, wherein the step of determining whether the vehicle is experiencing a shallow offset event comprises:
obtaining sensor data from an electronic frontal sensor of the vehicle; and
determining whether the vehicle is experiencing a shallow offset event using the sensor data.

8. The method of claim 1, wherein the step of determining whether the vehicle is experiencing a shallow offset event comprises:
obtaining camera data pertaining to an object proximate the vehicle from a camera onboard the vehicle; and
determining whether the vehicle is experiencing a shallow offset event using the camera data.

9. The method of claim 1, wherein the step of determining whether the vehicle is experiencing a shallow offset event comprises:
obtaining radar data pertaining to an object proximate the vehicle from a radar device onboard the vehicle; and
determining whether the vehicle is experiencing a shallow offset event using the radar data.

10. A system comprising:
a sensor onboard a vehicle and configured to provide sensor data; and
a processor onboard the vehicle and coupled to the sensor, the processor configured to:
determine, using the sensor data, whether the vehicle is experiencing a shallow offset event using the sensor data; and
initiate rotation of one of a plurality of wheels of the vehicle via instructions provided by a processor if the vehicle is experiencing a shallow offset event.

11. The system of claim 10, wherein the processor is configured to:
determine whether the shallow offset event is occurring on a driver side or a passenger side of the vehicle;
initiate rotation such that a front portion of a wheel on the driver side of the vehicle is turned inward toward a center of the vehicle, if the shallow offset event is determined to be occurring on the driver side of the vehicle; and
initiate rotation such that a front portion of a wheel on the passenger side of the vehicle is turned inward toward the center of the vehicle, if the shallow offset event is determined to be occurring on the passenger side of the vehicle.

12. The system of claim 10, wherein the processor is configured to initiate rotation of one of the plurality of wheels via an actuator coupled to the one of the plurality of wheels if the vehicle is experiencing a shallow offset event.

13. The system of claim 10, wherein the processor is configured to initiate rotation of one of the plurality of wheels via an actuator coupled to an axle of the vehicle if the vehicle is experiencing a shallow offset event.

14. The system of claim 10, wherein the processor is configured to initiate inflating of an airbag proximate one of the plurality of wheels if the vehicle is experiencing a shallow offset event.

15. The system of claim 10, wherein the processor is configured to:
determine a velocity of the vehicle using the sensor data; and
determining whether the vehicle is experiencing a shallow offset event using the velocity.

16. The system of claim 10, wherein the sensor comprises an electronic frontal sensor of the vehicle that is configured to provide the sensor data.

17. The system of claim 10, wherein;
the sensor comprises a camera onboard the vehicle that is configured to provide camera data pertaining to an object proximate the vehicle; and
the processor is configured to determine whether the vehicle is experiencing a shallow offset event using the camera data.

18. The system of claim 10, wherein;
the sensor comprises a radar device onboard the vehicle that is configured to provide radar data pertaining to an object proximate the vehicle; and
the processor is configured to determine whether the vehicle is experiencing a shallow offset event using the radar data.

19. A vehicle comprising:
a plurality of wheels; and
a drive system comprising:
a sensor configured to provide sensor data; and
a processor coupled to the sensor and configured to:
determine, using the sensor data, whether the vehicle is experiencing a shallow offset event using the sensor data; and
initiate rotation of one of the plurality of wheels of the vehicle via instructions provided by a processor if the vehicle is experiencing a shallow offset event.

20. The vehicle of claim 19, wherein the vehicle includes a driver side, a passenger side, and a center between the driver side and the passenger side, and the processor is configured to:
determine whether the shallow offset event is occurring on the driver side or the passenger side; and
initiate rotation such that a front portion of a wheel on the driver side is turned inward toward the center, if the shallow offset event is determined to be occurring on the driver side; and
initiate rotation such that a front portion of a wheel on the passenger side is turned inward toward the center, if the shallow offset event is determined to be occurring on the passenger side.
